(19) United States
(12) Patent Application Publication
(10) Pub. No.: US 2016/0052669 A1
(43) Pub. Date: Feb. 25, 2016

(54) Recycling wood pallets

(71) Applicant: George Edward Bell, III, Petersburg, VA (US)

(72) Inventor: George Edward Bell, III, Petersburg, VA (US)

(21) Appl. No.: 14/286,199

(22) Filed: Aug. 20, 2014

(51) Int. Cl. B65D 19/38; G06Q 90/00

(52) U.S. Cl. CPC B65D 19/38; G06Q 90/00; B65D 2519/00572; B65D 2519/00029; B65D 2519/00064; B65D 2519/00134; B65D 2519/00985

(57) ABSTRACT

To make useless wooden pallets useful by recycling them and in the process creating jobs that will help clean up the environment (go green).

BACKGROUND: There are many landfills and abandoned lots full of wooden pallets. Many of these pallets are damaged beyond repair and are no longer useful for their intended original purpose. Many of them are slightly damaged and could be useful for their intended purpose if repaired. Instead, these pallets are sitting in a landfill or in lots or fields, adding to the polluted state of our environment. I want to change this. I want to create jobs by starting up a company that will secure “useless” pallets preferably before they are sent to the landfill or abandoned in lots or fields.

SPECIFICATION: Recycle abandoned pallets (landfill, lots, fields, etc.) into useful products, such as mulch, starter wood, animal houses, furniture, ashes, animal bedding and the like. Recycling these pallets will help clean up the environment (remove tons of pallets from the environment), give an incentive for companies to properly dispose of their pallets (companies will no longer have to pay to dump their pallets at the landfill), and simultaneously create jobs.

1. convert useless and discarded pallets into useful products such as animal bedding, stater wood, animal houses, furnite, ash, etc.

2. re-use(for re-sale)the structurally sound nails from the useless pallets and sell the nails that are not structurally sound for scrap.
